(19) United States
(12) Patent Application Publication
(10) Pub. No.: US 2024/0042913 A1
(43) Pub. Date: Feb. 8, 2024

(54) Bedslide Lift Apparatus, And Systems And Methods Of Using Same

(71) Applicants: Philip Nathan, Royal Oak, MI (US); Gregory Weber, Houston, TX (US); Brandon John Congreve, Smyma, GA (US); Ronald Wayne Steele, Canton, GA (US)

(72) Inventors: Philip Nathan, Royal Oak, MI (US); Gregory Weber, Houston, TX (US); Brandon John Congreve, Smyma, GA (US); Ronald Wayne Steele, Canton, GA (US)

(21) Appl. No.: 18/364,941

(22) Filed: Aug. 3, 2023

Related U.S. Application Data
(60) Provisional application No. 63/394,840, filed on Aug. 3, 2022.

(51) Int. Cl. B60P 1/44; B60P 1/02; B62D 33/02

(52) U.S. Cl. CPC B60P 1/4414; B60P 1/02; B62D 33/0207; B60P 1/4471

(57) ABSTRACT

A lift apparatus having a support assembly that supports a slide panel assembly and an actuator that selectively adjusts the height or vertical position of the support assembly to thereby adjust the vertical position of the slide panel assembly. The support assembly is movably coupled to a bed of a vehicle (e.g., a truck). Vehicles including the lift apparatus and a slide assembly are also disclosed.

### CROSS-REFERENCE TO RELATED APPLICATION

This application claims priority to and the benefit of the filing date of U.S. Provisional Patent Application No. 63/394,840, filed Aug. 3, 2022, the entire contents of which are incorporated herein by reference.

### FIELD

This application relates generally to apparatuses, systems, and methods for lifting a slide positioned within a truck bed.

### BACKGROUND

A variety of different slide apparatuses can be positioned within a truck bed. Such slide apparatuses typically include a slide panel that is slidably coupled to a base, which is mounted to the truck bed. For example, a track or a frame can be mounted to the truck bed, and the slide panel can be slidably connected to the track or frame. In use, the slide panel can extend rearwardly of the truck bed, thereby providing a work surface that extends outwardly of the truck bed and provides increased access to items positioned on the slide panel.

Existing truck bed slide apparatuses do not provide for real-time adjustment of the operative height of the slide panel. Typically, the height of the slide panel is fixed, but the panel can be selectively advanced along the track or frame that is mounted to the truck bed. Thus, if it is necessary to position items on the slide panel at a higher location, then the items must be manually lifted above the surface of the slide panel. Similarly, during loading of the truck, it is necessary for users to lower items onto the surface of the slide panel. Accordingly, an improved truck bed slide apparatus is desirable.

### SUMMARY

Described herein, in various aspects, is a lift apparatus having a support assembly and an actuator. The support assembly is configured to be movably coupled to a bed of a vehicle (e.g., a truck) and to support a slide panel assembly having a base and a slide panel that is slidably coupled to the base. Vehicles including such a lift apparatus and a slide panel assembly are also disclosed. The slide panel assembly can be secured to the base of the slide panel assembly such that the slide panel is slidably coupled to both the base of the slide panel assembly and the support assembly of the lift apparatus.

In some aspects, the support assembly has an operative height or vertical position that is selectively adjustable to adjust a vertical position of the slide panel assembly. In these aspects, the actuator is configured to effect selective adjustment of the operative height of the support assembly or a vertical position of an upper surface of a support structure of the support assembly to thereby adjust the vertical position of the slide panel assembly. For example, a support structure of the support assembly can have an adjustable height, and the vertical position of the upper surface of the support structure can determine the vertical position of the slide panel assembly. As another example, a support structure of the support assembly can be suspended from the frame of the vehicle, and the vertical position of an upper surface of the support structure can be adjusted to modify the vertical position of the slide panel assembly.

Additional advantages of the invention will be set forth in part in the description that follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

These and other features of the preferred embodiments of the invention will become more apparent in the detailed description in which reference is made to the appended drawings wherein:

FIG. 1 is a schematic end view of an exemplary lift apparatus and a slide panel assembly positioned within a bed of a vehicle as disclosed herein.

FIG. 2A is a partially transparent perspective view of an exemplary lift apparatus positioned within the bed of a truck as disclosed herein. FIG. 2B is a close-up view of an exemplary angled support arm and upper frame element as further disclosed herein.

FIG. 3 is a partially transparent perspective view of another exemplary lift apparatus positioned within the bed of a truck as disclosed herein.

FIG. 4A is a partially transparent perspective view of another exemplary lift apparatus positioned within the bed of a truck as disclosed herein. FIGS. 4B-4D are isolated views of exemplary hydraulic actuators that can be included in the depicted lift apparatus.

FIG. 5 is a schematic end view of an exemplary lift apparatus and a slide panel assembly positioned within a bed of a vehicle as disclosed herein.

FIG. 6 is a perspective view of an exemplary lift apparatus positioned within the bed of a truck as disclosed herein.

### DETAILED DESCRIPTION

The disclosed apparatus, systems, and methods may be understood more readily by reference to the following detailed description of particular embodiments and the examples included therein and to the Figures and their previous and following description.

It is to be understood that the terminology used herein is for the purpose of describing particular embodiments only and is not intended to limit the scope of the present invention which will be limited only by the appended claims.

It must be noted that as used herein and in the appended claims, the singular forms “a”, “an,” and “the” can include plural references unless the context clearly dictates otherwise. Thus, for example, reference to “an actuator” can include one or more of such actuators, and so forth. However, wherever a singular form is used to refer to an element, unless the context dictates otherwise, it is understood that the application is providing support for embodiments in which only one of those elements is provided, as well as embodiments in which a plurality of those embodiments is provided.

“Optional” or “optionally” means that the subsequently described event, circumstance, or material may or may not occur or be present, and that the description includes instances where the event, circumstance, or material occurs or is present and instances where it does not occur or is not present.

Ranges may be expressed herein as from “about” one particular value, and/or to “about” another particular value. When such a range is expressed, also specifically contemplated and considered disclosed is the range from the one particular value and/or to the other particular value unless the context specifically indicates otherwise. Similarly, when values are expressed as approximations, by use of the antecedent “about,” it will be understood that the particular value forms another, specifically contemplated embodiment that should be considered disclosed unless the context specifically indicates otherwise. It will be further understood that the endpoints of each of the ranges are significant both in relation to the other endpoint, and independently of the other endpoint unless the context specifically indicates otherwise. Finally, it should be understood that all of the individual values and sub-ranges of values contained within an explicitly disclosed range are also specifically contemplated and should be considered disclosed unless the context specifically indicates otherwise. The foregoing applies regardless of whether in particular cases some or all of these embodiments are explicitly disclosed.

Optionally, in some aspects, when values are approximated by use of the antecedents “about,” “substantially,” or “generally,” it is contemplated that values within up to 15%, up to 10%, up to 5%, or up to 1% (above or below) of the particularly stated value or characteristic can be included within the scope of those aspects. In further optional aspects, when angular orientations are approximated by use of the antecedents “about,” “substantially,” or “generally,” it is contemplated that angular values within up to 15 degrees, up to 10 degrees, up to 5 degrees, or up to 1 degree (above or below) of the particularly stated angular orientation can be included within the scope of those aspects.

Unless defined otherwise, all technical and scientific terms used herein have the same meanings as commonly understood by one of skill in the art to which the disclosed apparatus, system, and method belong. Although any apparatus, systems, and methods and materials similar or equivalent to those described herein can be used in the practice or testing of the present apparatus, system, and method, the particularly useful methods, devices, systems, and materials are as described.

Throughout the description and claims of this specification, the word “comprise” and variations of the word, such as “comprising” and “comprises,” means “including but not limited to,” and is not intended to exclude, for example, other additives, components, integers or steps. In particular, in methods stated as comprising one or more steps or operations it is specifically contemplated that each step comprises what is listed (unless that step includes a limiting term such as “consisting of”), meaning that each step is not intended to exclude, for example, other additives, components, integers or steps that are not listed in the step. Unless otherwise stated, for any disclosed embodiment that “comprises” a combination of features as disclosed herein, this description should be treated as disclosing other embodiments that “consist of” or “consist essentially of” the same combination of features recited in the disclosed embodiment.

As used herein, the terms “bed slide assembly” and “slide panel assembly” are used interchangeably. Although specific examples of bed slide assemblies/slide panel assemblies are disclosed herein, it is contemplated that any suitable structure can be used. Typically, such slide assemblies include a base that is affixed to the bed (or other storage area) of a vehicle (e.g., truck), and a slide panel or platform is permitted to slide relative to the base to extend rearwardly of the vehicle, thereby providing increased access to the slide panel or platform. Such slide assemblies typically include a stop element (e.g., a latch) that is configured to prevent the slide panel or platform from becoming uncoupled from the base. However, because the bases of such slide assemblies are mounted directly to the vehicle, the vertical location of such slide assemblies is fixed. Accordingly, even when conventional slide assemblies are extended to provide access to the slide panel or platform, users of the slide assemblies are required to manually lift items from the slide panel or lower items to the slide panel.

As used herein, the term “coupled” can in some aspects refer to a direct engagement between two components, and in other aspects, does not require direct contact or engagement between components, provided the necessary operative or functional relationship is achieved. For example, two elements can be coupled to one another when movement of one element effects a corresponding movement of the second element, even if a third component provides a connection between the two elements that allows for the corresponding movement to be achieved.

Disclosed herein is a lift apparatus that can be coupled to the slide assembly to allow for selective adjustment of the vertical position of the slide panel or platform. Although specific examples of the lift apparatus are disclosed herein, it is contemplated that the lift apparatus can include any actuator configuration that is capable of imparting upward or downward vertical motion to the slide assembly. In particular, it is contemplated that the lift apparatus can have a support assembly and an actuator. The support assembly can be movably coupled to a bed of a vehicle (e.g., a truck) and support a slide panel assembly (e.g., a base structure (such as a frame) and a slide panel that slides relative to the base structure) above the support assembly. Vehicles including such a lift apparatus and a slide panel assembly are also disclosed. In such vehicles, the support assembly can be mounted or otherwise securely positioned within the vehicle (e.g., within the bed of the vehicle), and the base (e.g., frame) of the slide panel assembly can be secured to the support assembly such that the slide panel is slidably coupled to both the base of the slide assembly and the support assembly of the lift apparatus.

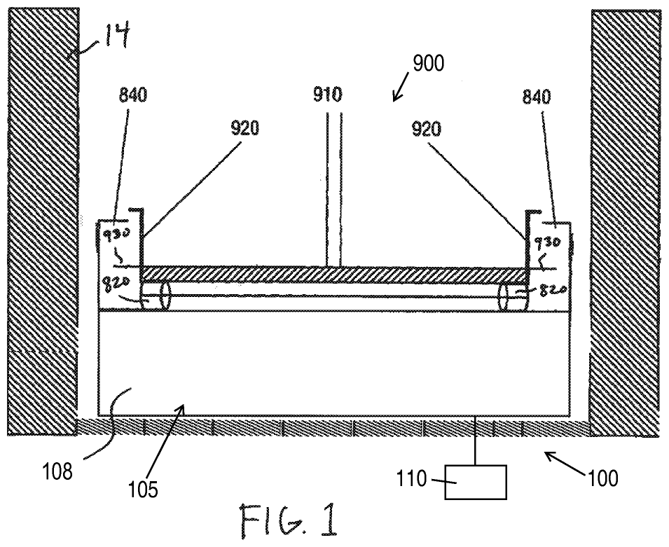

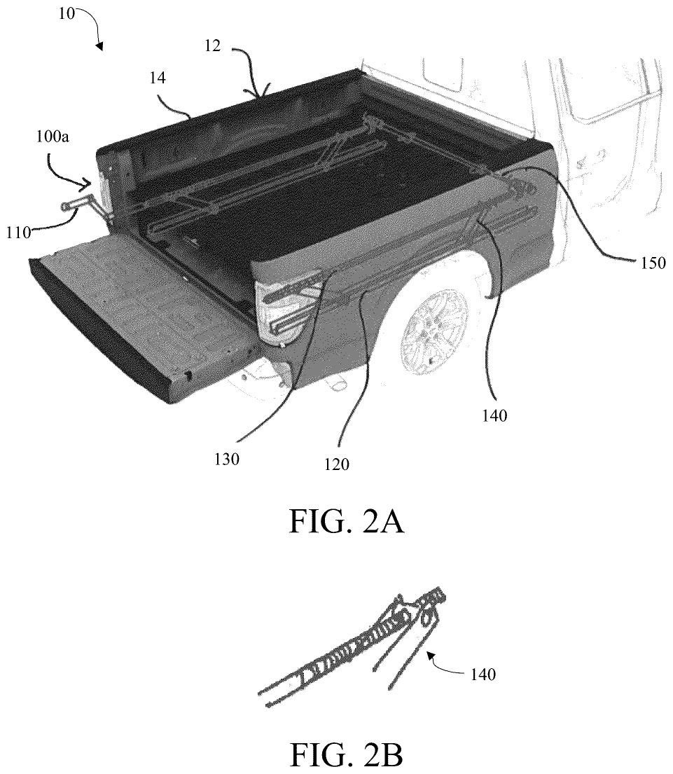

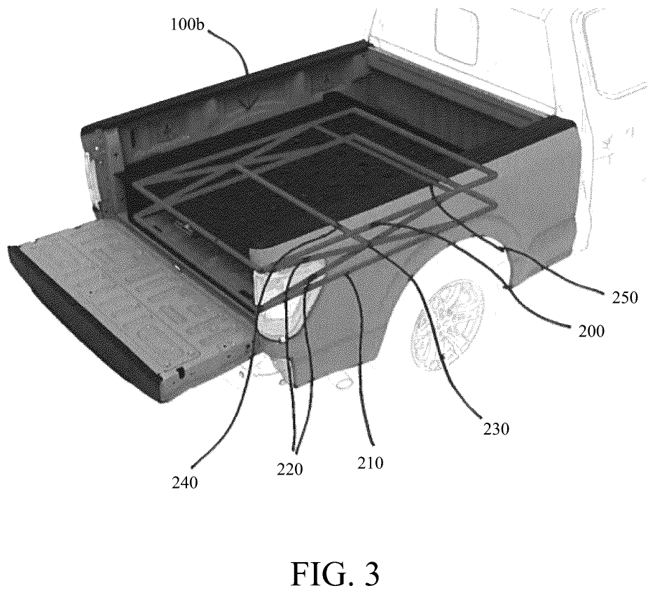

Referring to FIGS. 1-4, a lift apparatus 100 (e.g., a lift apparatus 100a, 100b, 100c, 100d as disclosed herein) can include a support assembly 105 and an actuator 110. The support assembly 105 can be configured to be movably coupled to a bed 12 of a vehicle (e.g., truck) 10 and have a support structure 108 (e.g., a support panel, a cradle, or a track) that is configured to support a slide panel assembly 900. The support assembly (e.g., the support structure of the support assembly) has an operative height or vertical position that is selectively adjustable to adjust a vertical position of the slide panel assembly. In exemplary aspects, the actuator 110 can be configured to effect selective adjustment of the operative height of the support assembly. In exemplary aspects, and with reference to FIGS. 2-3, the support assembly can comprise a jack, and the actuator 110 can comprise a crank coupled to the jack.

With reference to FIGS. 2A-2B, in some aspects, the lift apparatus 100a can have a jack that comprises: a bottom frame structure 120 secured to the bed 12 of the truck; an upper frame structure 130 movably coupled to the bottom frame structure; and a plurality of angled support arms 140 that extend between the bottom frame structure and the upper frame structure and that are pivotably coupled to the bottom frame structure. In exemplary aspects, the upper frame structure 130 can be coupled to the support structure 108 of the support assembly 105 such that the vertical position of the upper frame structure determines the vertical position of the support structure 108. For example, it is contemplated that the upper frame structure can engage a bottom portion of the support structure 108, and the frame structure can define at least a portion of the operative height of the support assembly (with the vertical position of the support structure 108 determining the vertical position of the slide panel assembly 900). Optionally, in these aspects, the upper frame structure 130 can comprise a threaded outer surface, and the plurality of angled support arms 140 can define respective threaded openings that receive and engage the threaded outer surface of the upper frame structure (see FIG. 2B). In use, it is contemplated that the angled support arms 140 can operate in the manner of a modified scissors jack, with the actuator imparting rotation to the upper frame structure 130. Optionally, in some exemplary aspects, and as shown in FIG. 2, the upper frame structure 130 can comprise first and second upper frame elements that are spaced apart along a transverse axis of the bed of the truck, with the first upper frame element being coupled to the crank. In these aspects, the upper frame structure 130 can further comprise a transverse frame element 150 that extends along the transverse axis of the bed of the truck and is coupled to the first and second upper frame elements such that rotation of the first upper frame element effects a corresponding rotation of the transverse frame element and the second upper frame element. For example, it is contemplated that the first and second upper frame elements can be coupled to the transverse frame element via geared connections that translate the rotation of the first upper frame element into corresponding rotation of the transverse frame element and the second upper frame element. Rather than providing a single actuator (e.g., crank), it is contemplated that the lift apparatus can comprise first and second actuators (e.g., first and second cranks). For example, in exemplary aspects, the upper frame structure can comprise first and second upper frame elements that are spaced apart along a transverse axis of the bed of the truck, with the first upper frame element coupled to the first crank, and the second upper frame element is coupled to the second crank. In operation, it is contemplated that the actuator(s) 110 can impart rotational motion to the upper frame structure in a first direction that causes the angled support arms 140 to translate along the upper frame elements such that the support arms approach a vertical orientation, thereby increasing the operative height of the support assembly. When the actuator(s) 110 impart rotational motion in the opposite direction, the angled support arms 140 translate along the upper frame elements such that the support arms approach a horizontal orientation, thereby decreasing the operative height of the support assembly.

With reference to FIG. 3, in some aspects, a lift apparatus 100b can comprise a support assembly including a jack having: a bottom frame structure 210 secured to the bed of the truck; an upper frame structure 200 movably coupled to the bottom frame structure; and first and second sets of scissor arms 220 that are spaced apart along a transverse axis of the bed of the truck. In these aspects, the scissor arms 220 of each of the first and second sets of scissor arms extend between the bottom frame structure 210 and the upper frame structure 200 and are pivotably coupled to one another at a respective pivot point 230. In exemplary aspects, the lift apparatus 100b can further comprise a transverse support bar 240 extending between the pivot points 230 of the first and second sets of scissor arms 220. In these aspects, it is contemplated that the first and second sets of scissor arms 220 can be pivotably coupled to the transverse support bar 240. Optionally, in further exemplary aspects, the upper frame structure 200 can comprise first and second outer frame elements and a transverse frame element 250 that extends along the transverse axis between the first and second outer frame elements. In these aspects, the transverse frame element 250 can be positioned forwardly of the transverse support bar 240. In exemplary aspects, the actuator 110 (e.g., crank) can be coupled to the transverse support bar 240 such that movement of the transverse support bar 240 effects adjustment of the operative height of the jack. Additionally, or alternatively, it is contemplated that the actuator can be coupled to one or more portions of the upper frame structure 200 to effect adjustment of the operative height of the jack.

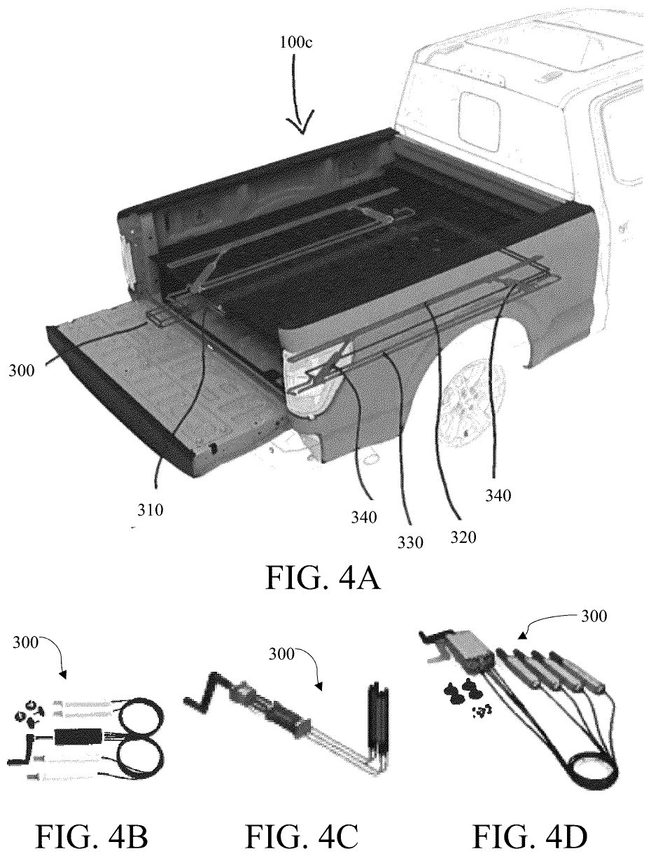

With reference to FIG. 4, in some aspects, a lift apparatus 100c can have a support assembly that includes a jack and a hydraulic actuator 300 coupled to the jack via one or more hydraulic connections 310. Optionally, in some aspects, the hydraulic actuator 300 can comprise a hand crank. However, it is contemplated that any conventional hydraulic actuator (e.g., a portable electrohydraulic pump) can be used. In exemplary aspects, the jack comprises: a bottom frame structure 330 secured to the bed of the vehicle (e.g., truck); an upper frame structure 320 movably coupled to the bottom frame structure; and a plurality of hydraulic cylinders 340 that movably couple the upper frame structure to the bottom frame structure. In these aspects, the hydraulic actuator 300 is in communication with the plurality of hydraulic cylinders 340. For example, it is contemplated that a single hydraulic actuator 300 can be used. In further aspects, the bottom frame structure 330 can comprise first and second bottom frame elements mounted to the bed of the truck, and the upper frame structure 320 can comprise first and second upper frame elements that are respectively movably coupled to the first and second bottom frame elements via respective hydraulic cylinders. As shown in FIG. 4, it is contemplated that two angularly oriented hydraulic cylinders can movably couple each respective upper frame element to a corresponding lower frame element (such that the support assembly includes a total of four hydraulic cylinders). Optionally, the bottom portions of the hydraulic cylinders can be positioned proximate respective corners of the bed of the vehicle. Upon activation of the actuator, it is contemplated that the operative length of each hydraulic cylinder can increase, thereby increasing the operative height of the jack.

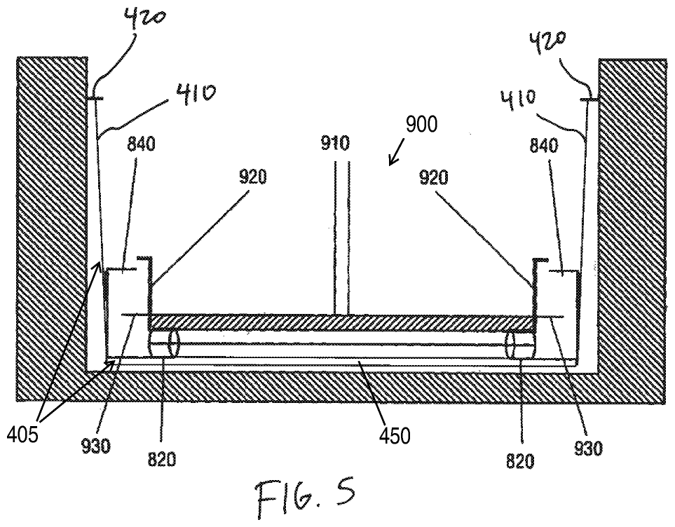

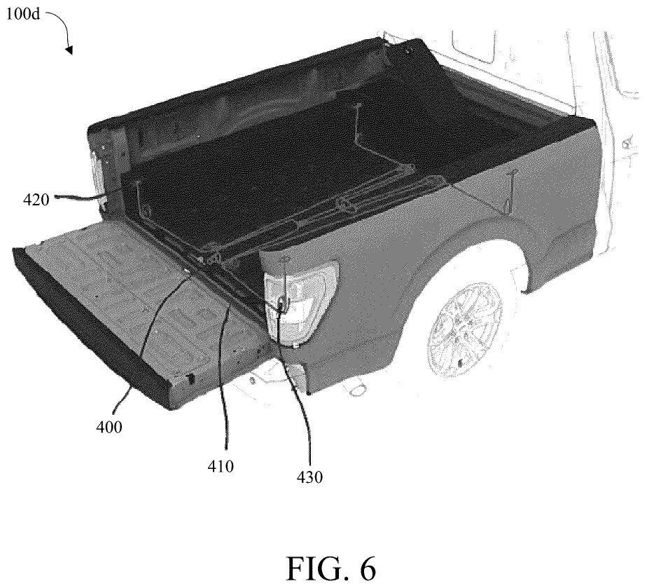

With reference to FIGS. 5-6, in some aspects, a lift apparatus 100d can include a support assembly 405 that is configured to be movably coupled to a frame of a bed of a truck and to support a slide panel assembly 900. In these aspects, the support assembly can have a support structure 450 (e.g., a panel, a cradle, a track) that is suspended from the bed of the truck and that is configured to be positioned underneath the slide panel assembly 900 to provide support to the slide panel assembly. In use, the vertical position of the support structure 450 can be selectively adjustable to thereby adjust a vertical position of the slide panel assembly. The lift apparatus 100d can further comprise an actuator 400 that is configured to effect selective adjustment of the vertical position of the support structure of the support assembly. In exemplary aspects, the support assembly 405 of the lift apparatus 100d can comprise a plurality of cables 410 that are configured to be secured to and suspended from the frame 420 of the bed of the truck. Optionally, the frame 420 can define a horizontal projection (or a plurality of projections) to which the cables are secured. In other optional aspects, the plurality of cables 410 can comprise four cables, with each cable being secured to a respective portion (e.g., corner) of the vehicle bed. The plurality of cables 410 have respective operative lengths, and each of the plurality of cables is coupled to the actuator 400 such that movement of the actuator effects a corresponding adjustment to the operative length of each respective cable of the plurality of cables. In exemplary aspects, the support assembly can comprise a plurality of pulleys 430 that are in engagement with one or more cables 410 of the plurality of cables. Optionally, in exemplary aspects, the actuator 400 can comprise an actuation cable that is coupled to each cable 410 of the plurality of cables. In these aspects, it is contemplated that the actuator 400 can further comprise a single winch that is coupled to the actuation cable, and the winch can be used to adjust the tension of the cables 410. For example, rotation of the winch in a first direction can increase the tension of (and decrease the operative lengths of) the cables 410, thereby raising the vertical position of the slide panel assembly. In this example, rotation of the winch in an opposite direction can decrease the tension of (and increase the operative lengths of) the cables 410, thereby lowering the vertical position of the slide panel assembly. Optionally, the cable within the winch can be held in place using a ratcheting mechanism. In order to reverse the rotation of the winch, the ratcheting mechanism can be selectively disengaged, or a clutch can be provided to allow the winch to be cranked back down. Optionally, the winch can comprise a spool that is coupled to a crank that can be selectively rotated to effect a corresponding rotation of the spool to permit adjustment of the tension in the cables 410. In other aspects, the actuator 400 can comprise a linear actuator that is coupled to an actuation cable that is in turn coupled to the plurality of cables 410. In these aspects, it is contemplated that the linear actuator can selectively apply an axial force to the actuation cable to thereby modify the amount of tension applied to the cables 410, leading to a corresponding adjustment in the vertical position of the slide panel assembly.

In exemplary aspects, the disclosed lift apparatus 100, 100a, 100b, 100c, 100d can be incorporated into a vehicle 10 (e.g., a truck) having a bed 12. The bed can have a wall 14. The vehicle 10 can further comprise a slide panel assembly 900 that is supported by the support assembly of the lift apparatus. In exemplary aspects, a base (e.g., frame or fixed rails) of the slide panel assembly can be secured to an upper portion of the support assembly of the lift apparatus.

In exemplary aspects, and with reference to FIGS. 1 and 5, the slide panel assembly 900 that is supported by the lift apparatus can optionally comprise two bottom rails positioned parallel to one another. The bottom rails can be joined together by one or more cross supports. A plurality of bearings 820 can be provided on the side of each bottom rail, beneath respective top securing rails 840, which can optionally be secured to the lift apparatus and effectively serve as a base structure for the slide panel assembly. The slide panel can include a platform 910 that sits upon and is fastened to a platform base. On each side of the platform base, a slide rail 930 can be provided. The slide rails 930 can slide on the bearings 820. Side guards 920 can cover the slide rail 930 and fit under the outer edge of platform 910.

In use, it is contemplated that the disclosed lift apparatus can allow for raising and lowering of a bedslide with minimal strength and/or with use of an automated actuator (e.g., one or more electric motors or a drill). It is further contemplated that the components of the disclosed lift apparatus can be easily serviced and/or replaced. It is further contemplated that the disclosed lift apparatus will require minimal maintenance.

Although the foregoing invention has been described in some detail by way of illustration and example for purposes of clarity of understanding, certain changes and modifications may be practiced within the scope of the appended claims.

What is claimed is:

1. A lift apparatus comprising:
a support assembly configured to be movably coupled to a bed of a truck and having a support structure configured to engage a slide panel assembly, wherein the support structure has an operative vertical position that is selectively adjustable to thereby adjust a vertical position of the slide panel assembly; and
an actuator that is configured to effect selective adjustment of the vertical position of the support structure of the support assembly.

2. The lift apparatus of claim 1, wherein the support assembly comprises a jack, and wherein the actuator comprises a crank coupled to the jack.

3. The lift apparatus of claim 2, wherein the jack comprises:
a bottom frame structure secured to the bed of the truck;
an upper frame structure movably coupled to the bottom frame structure and coupled to the support structure of the support assembly; and
a plurality of angled support arms that extend between the bottom frame structure and the upper frame structure and that are pivotably coupled to the bottom frame structure.

4. The lift apparatus of claim 3, wherein the upper frame structure comprises a threaded outer surface, and wherein the plurality of angled support arms define respective threaded openings that receive and engage the threaded outer surface of the upper frame structure.

5. The lift apparatus of claim 4, wherein the upper frame structure comprises:
first and second upper frame elements that are spaced apart along a transverse axis of the bed of the truck, the first upper frame element being coupled to the crank; and
a transverse frame element that extends along the transverse axis of the bed of the truck and is threadedly coupled to the first and second upper frame elements such that rotation of the first upper frame element effects a corresponding rotation of the transverse frame element and the second upper frame element.

6. The lift apparatus of claim 4, wherein the actuator comprises first and second cranks, and wherein the upper frame structure comprises:
first and second upper frame elements that are spaced apart along a transverse axis of the bed of the truck, each of the first and second upper frame elements being coupled to the support structure of the support assembly,
wherein the first upper frame element is coupled to the first crank, and
wherein the second upper frame element is coupled to the second crank.

7. The lift apparatus of claim 2, wherein the jack comprises:
a bottom frame structure secured to the bed of the truck;
an upper frame structure movably coupled to the bottom frame structure and coupled to the support structure of the support assembly; and
first and second sets of scissor arms that are spaced apart along a transverse axis of the bed of the truck, wherein the scissor arms of each of the first and second sets of scissor arms extend between the bottom frame structure and the upper frame structure and are pivotably coupled to one another at a respective pivot point.

8. The lift apparatus of claim 7, further comprising a transverse support bar extending between the pivot points of the first and second sets of scissor arms, and wherein the first and second sets of scissor arms are pivotably coupled to the transverse support bar.

9. The lift apparatus of claim 8, wherein the upper frame structure comprises first and second outer frame elements and a transverse frame element that extends along the transverse axis between the first and second outer frame elements, wherein the transverse frame element is positioned forwardly of the transverse support bar.

10. The lift apparatus of claim 8, wherein the actuator is coupled to the transverse support bar such that movement of the transverse support bar effects adjustment of the operative height of the jack.

11. The lift apparatus of claim 1, wherein the support assembly comprises a jack, and wherein the actuator comprises a hydraulic actuator coupled to the jack.

12. The lift apparatus of claim 11, wherein the hydraulic actuator comprises a hand crank.

13. The lift apparatus of claim 11, wherein the jack comprises:
a bottom frame structure secured to the bed of the truck;
an upper frame structure movably coupled to the bottom frame structure and coupled to the support structure of the support assembly; and
a plurality of hydraulic cylinders that movably couple the upper frame structure to the bottom frame structure,
wherein the hydraulic actuator is in communication with the plurality of hydraulic cylinders.

14. The lift apparatus of claim 13, wherein the bottom frame structure comprises first and second bottom frame elements mounted to the bed of the truck, and wherein the upper frame structure comprises first and second upper frame elements that are respectively movably coupled to the first and second bottom frame elements.

15. The lift apparatus of claim 1, wherein the support assembly comprises:
a plurality of cables configured to be secured to and suspended from the frame of the bed of the truck and to be coupled to the support structure, wherein the plurality of cables have respective operative lengths, and wherein each of the plurality of cables is coupled to the actuator such that movement of the actuator effects a corresponding adjustment to the operative length of each respective cable of the plurality of cables.

16. The lift apparatus of claim 15, wherein the support assembly comprises a plurality of pulleys that are in engagement with one or more cables of the plurality of cables.

17. The lift apparatus of claim 15, wherein the actuator comprises an actuation cable that is coupled to each cable of the plurality of cables.

18. A vehicle having a bed and comprising:
a slide assembly; and
a lift apparatus, wherein the lift apparatus has:
a support assembly movably coupled to the bed and having a support structure in engagement with the slide assembly, wherein the support structure has an operative vertical position that is selectively adjustable to thereby adjust a vertical position of the slide assembly; and
an actuator that is configured to effect selective adjustment of the vertical position of the support structure of the support assembly.

19. The vehicle of claim 18, wherein the support assembly comprises a jack, and wherein the actuator comprises a crank or a hydraulic actuator coupled to the jack.

20. The vehicle of claim 18, wherein the support assembly comprises:
a plurality of cables secured to and suspended from the frame of the bed of the vehicle and coupled to the support structure, wherein the plurality of cables have respective operative lengths, and wherein each of the plurality of cables is coupled to the actuator such that movement of the actuator effects a corresponding adjustment to the operative length of each respective cable of the plurality of cables.
